(19) United States
(12) Patent Application Publication
(10) Pub. No.: US 2015/0138762 A1
(43) Pub. Date: May 21, 2015

(54) Lighting Device

(71) Applicant: Taixing Corporation, Tortola (VG)

(72) Inventor: Chung SHING, Hong Kong (HK)

(73) Assignee: Taixing Corporation, Tortola (VG)

(21) Appl. No.: 14/085,151

(22) Filed: Nov. 20, 2013

(51) Int. Cl. F21S 9/03; F21S 6/00

(52) U.S. Cl. CPC F21S 9/037; F21S 6/001
USPC 362/183

(57) ABSTRACT

A lighting device (10) is disclosed as including a solar power panel (12) and a housing (14) with two circular recesses (24, 26). The solar power panel is adapted to power a first lighting element (23) releasably engaged with the housing and a second lighting element (32) movable relative to the housing. The circular recesses are each adapted to releasably engage with a respective translucent cylindrical tube (28, 30).

### TECHNICAL FIELD

This invention relates to a lighting device and, in particular, such a lighting device powered by at least one solar power panel.

### BACKGROUND OF THE INVENTION

Solar power panels (also called “solar panels”) are employed in various applications to receive light energy, e.g. from the sun, to generate electricity through the photovoltaic effect, and to supply electricity to various electric appliances. One such possible application is to use solar power panels to power electric lighting elements, e.g. liquid crystal display (LCD) elements and light emitting diodes (LEDs). However, despite the existence of such electric lighting elements, consumers still prefer lighting devices with the appearance of conventional lighting devices, such as fluorescent tubes or candles.

### SUMMARY OF THE INVENTION

It is thus an object of the present invention to provide a lighting device in which the aforesaid shortcomings are mitigated or at least to provide a useful alternative to the trade and public.

According to the present invention, there is provided a lighting device including a solar power panel, and a housing with an engagement structure, wherein said solar power panel is adapted to power a first lighting element releasably engaged with said housing, wherein said engagement structure is adapted to releasably engage with at least a first tube member, and wherein said solar power panel is adapted to power a second lighting element movable relative to said housing.

### BRIEF DESCRIPTION OF THE DRAWINGS

An electric lighting device according to an embodiment of the present invention will now be described, by way of example only, with reference to the accompanying drawings, in which:

FIG. 1 is a top view of an electric lighting device according to an embodiment of the present invention;

FIG. 2 is a side view of the electric lighting device of FIG. 1 with translucent tubes attached;

FIG. 3 is a sectional taken along the line A-A of FIG. 1; and

FIG. 4 is a side view of the electric lighting device of FIG. 1, with a candle-shaped light attached.

### DETAILED DESCRIPTION OF THE INVENTION

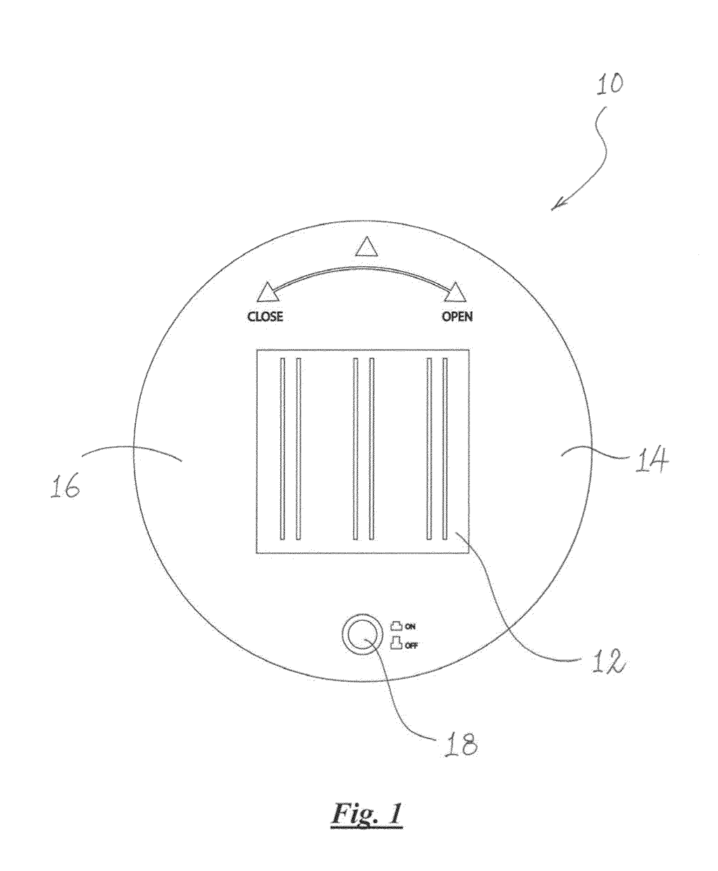

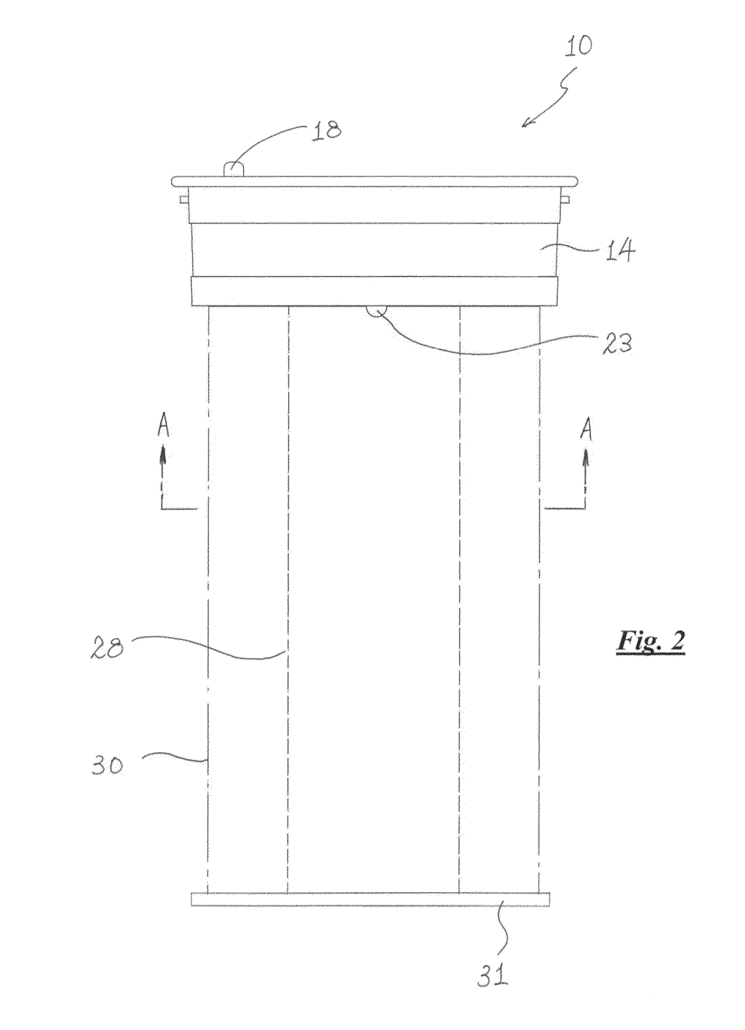

An electric lighting device according to an embodiment of the present invention is shown in FIGS. 1 and 2, generally designated as 10. The lighting device 10 includes a solar power panel (also called a “solar panel”) 12 fixedly engaged with a housing 14. On an upper major surface 16 of the housing 14 is an ON/OFF switch button 18 which may be actuated by a user to selectively enable and disable powering of electric lighting elements (to be discussed below) by the solar power panel 12.

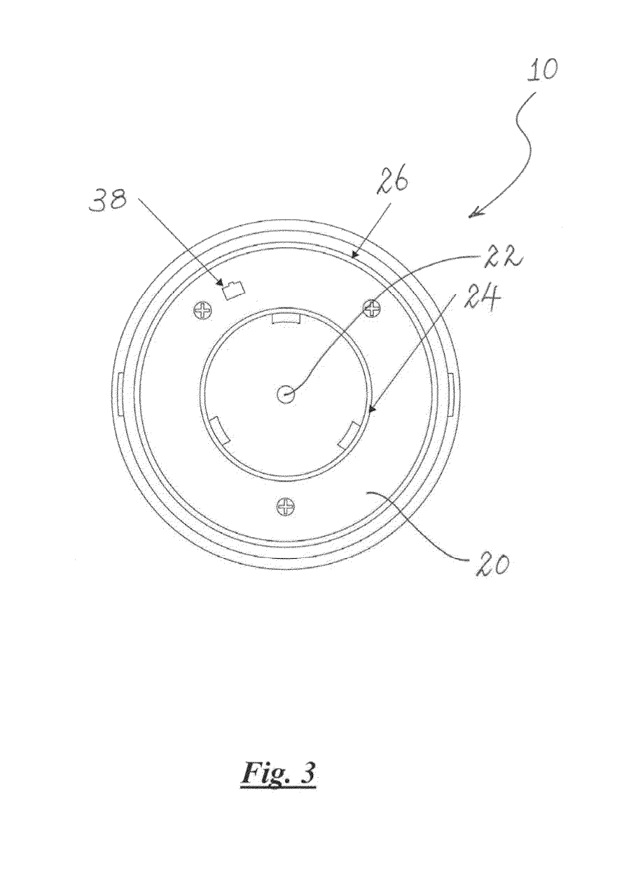

As shown in FIG. 3, a lower major surface 20 of the housing 14 is provided with a central connecting point 22 to which a first electric lighting element 23 (such as an LCD or an LED) (see FIG. 2) may be releasably engaged and electrically connected, so as to be powered by the solar power panel 12. As most people find it uncomfortable to look at light emitted by an LCD or LED, structure is provided for releasable engagement with translucent cylindrical tubes (to be discussed below), so as to mimic the appearance of a fluorescent tube.

As shown in FIG. 3, the lower major surface 20 of the housing 14 is further provided with an inner endless, circular recess 24 and an outer endless, circular recess 26. The recesses 24, 26 are concentric with each other, with the connection point 22 being their common center. The inner recess 24 is releasably engageable with a translucent cylindrical tube 28 of a smaller diameter, for example, 5 cm, whereas the outer recess 26 is releasably engageable with a translucent cylindrical tube 30 of a larger diameter, for example, 8 cm. In normal use, only one of the smaller tube 28 and the larger tube 30 is engaged with the housing 14 via the circular recess 24 or the circular recess 26, as appropriate.

The housing 14 is provided with a locking mechanism for assembling and disassembling the translucent tube 28, 30 with the housing 14. More particularly, and taking the translucent tube 28 as an example, when the translucent tube 28 is already engaged with the housing 14, the housing 14 is rotatable relative to the tube 28 in the clockwise direction (in the sense of FIG. 1, i.e. towards the word “OPEN” on the upper surface 16 of the housing 14) to allow the tube 28 to be disengaged from the housing 14. The housing 14 is then rotatable relative to the tube 28 in the counter-clockwise direction (again in the sense of FIG. 1, i.e. towards the word “CLOSE” on the upper surface 16 of the housing 14) to lock the tube 28 against movement relative to the housing 14 in the axial direction. A support 31 is provided to provide support to the tube 28, 30 from below.

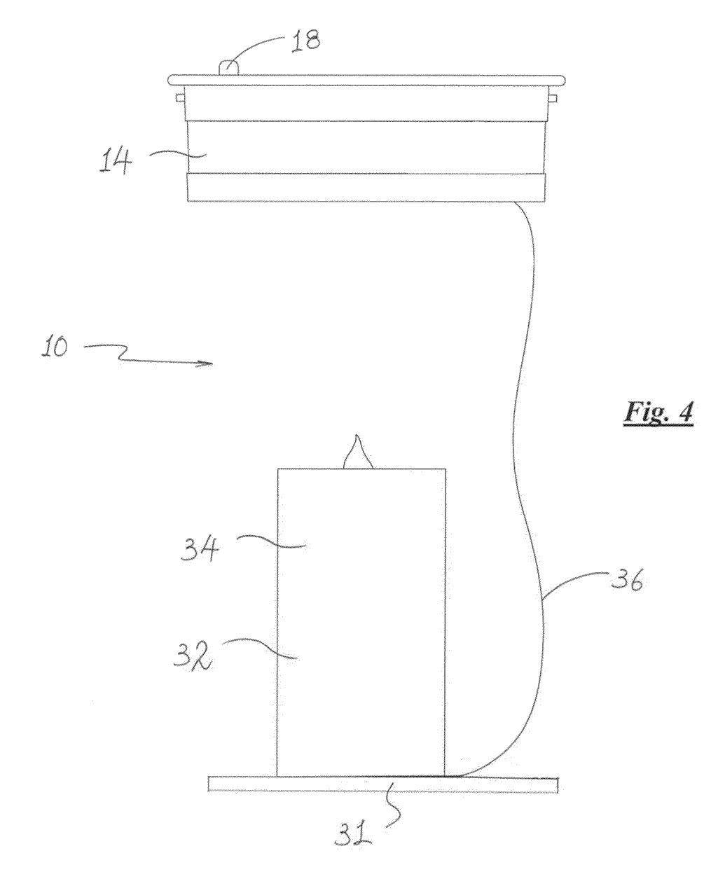

A second electric lighting element 32 in the form of an electric lighting member (such as an LCD or an LED) positioned within a body 34 in the shape of a candle with a flame is shown in FIG. 4 as being electrically connected with the housing 14 via an electric cable 36. One end of the electric cable 36 is electrically connected with the second electric lighting element 32, and another end of the electric cable 36 is connected with the solar power panel 12 via a connection point 38 on the lower major surface 20 of the housing 14. The body 34 of the second electric lighting element 32 sits on the support 31. It can be seen that the second electric lighting element 32 (with the support 31) is movable relative to the housing 14. Such an arrangement allows the lighting device 10 to mimic the appearance of a burning candle.

By way of such an arrangement, the solar power panel 12 may be used for powering both the first electric lighting element 23 and the second electric lighting element 32 simultaneously, although in normal use, only one of the first electric lighting element 23 and the second electric lighting element 32 is usually engaged with the housing 14, to be powered by the solar power panel 12.

In use, it is possible to fixedly engage the housing 14 with an upper part of an outer frame (not shown), which may be made of such materials as rattan or plastics, and fixedly engage the support 31 to a lower part of the outer frame. When the second electric lighting element 32 is assembled to the housing 14 and the support 31, the lower part of the outer frame may be moved relative to the upper part of the outer frame.

It should be understood that the above only illustrates an example whereby the present invention may be carried out, and that various modifications and/or alterations may be made thereto without departing from the spirit of the invention. It should also be understood that various features of the invention which are, for brevity, described here in the context of a single embodiment, may also be provided separately or in any appropriate sub-combinations.

1. A lighting device comprising:
a solar power panel, and
a housing with an engagement structure,
wherein said solar power panel is adapted to power a first lighting element releasably engaged with said housing,
wherein said engagement structure is adapted to releasably engage with at least a first tube member, and
wherein said solar power panel is adapted to power a second lighting element movable relative to said housing.

2. The lighting device of claim 1 wherein said solar power panel is fixedly engaged with said housing.

3. The lighting device of claim 1 wherein said engagement structure includes a first endless recess on a major surface of said housing for releasable engagement with said first tube member.

4. The lighting device of claim 3 wherein said engagement structure includes a second endless recess on said major surface of said housing for releasable engagement with a second tube member.

5. The lighting device of claim 4 wherein said first and second endless recesses are circular in shape.

6. The lighting device of claim 4 wherein said first and second tube member are cylindrical in shape, and wherein the diameter of the second tube member is larger than the diameter of the first tube member.

7. The lighting device of claim 4 wherein said first and second tube members are translucent.

8. The lighting device of claim 1 wherein said second lighting element includes a body in the shape of a candle with a flame.

9. The lighting device of claim 1 wherein said solar power panel is adapted to selectively power one of said first lighting element and said second lighting element.
